(19) United States
(12) Patent Application Publication
(10) Pub. No.: US 2010/0308706 A1
(43) Pub. Date: Dec. 9, 2010

(54) HIGH-PRESSURE DISCHARGE LAMP

(75) Inventors: Bernhard Schalk, Eching (DE); Klaus Stockwald, Germering (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/679,040

(22) PCT Filed: Aug. 19, 2008
(86) PCT No.: PCT/EP08/60860

§ 371 Date: Mar. 19, 2010

(30) Foreign Application Priority Data
Sep. 21, 2007 (DE) 10 2007 045 079.8

(51) Int. Cl. H01J 61/52

(52) U.S. Cl. 313/42

(57) ABSTRACT

A high-pressure discharge lamp may include an elongate ceramic discharge vessel with a central part and two ends and an axis, the ends being closed by seals, electrodes which extend into the discharge volume enclosed by the discharge vessel being anchored in the seals, and a fill which contains metal halides being accommodated in the discharge vessel, wherein a ring structure, which is separated from the seal and extends around the seal, is placed on at least one end.

### TECHNICAL FIELD

The invention is based on a high-pressure discharge lamp according to the preamble of claim 1. Such lamps are, in particular, high-pressure discharge lamps having a ceramic discharge vessel for general lighting.

### PRIOR ART

U.S. Pat. No. 4,970,431 discloses a high-pressure sodium discharge lamp, in which the bulb of the discharge vessel is made of ceramic. Fin-like projections, which serve to dissipate heat, are fitted on the cylindrical ends of the discharge vessel.

EP-A 506 182 discloses coatings of graphite or carbon or the like, which are applied onto ceramic discharge vessels at the ends in order to effect cooling.

### SUMMARY OF THE INVENTION

It is an object of the present invention to provide a high-pressure discharge lamp, the color variance of which is reduced considerably relative to prior lamps.

This object is achieved by the characterizing features of claim 1.

Particularly advantageous configurations may be found in the dependent claims.

The high-pressure discharge lamp is equipped with an elongate ceramic discharge vessel. The discharge vessel defines a lamp axis and has a central part and two end regions, which are respectively closed by seals, electrodes which extend into the discharge volume enclosed by the discharge vessel being anchored in the seals, and a fill which contains metal halides furthermore being accommodated in the discharge vessel. A ring structure, which as regards at least its base body extends essentially axially parallel outward and is separated from the seal, is placed on at least one end region. The seals are preferably capillaries.

The invention relates in particular to lamps having an increased aspect ratio, or lamps which have a shortened structure for the seals. The end region preferably has a tapering inner contour in the electrode back space. This means that the central part of the discharge vessel has a maximum or constant inner diameter ID and the end regions have a smaller inner diameter.

The ring structure is preferably formed concentrically around the electrode construction or the seal in the end region. The discharge vessel typically consists of ceramics containing aluminum, such as PCA or YAG, AlN or AlYO₃. A free-standing cooling structure separated from the seal is used, which in particular is itself formed from ceramic and may in particular be an integral component of the end region. It may however also be a separate component made of translucent ceramic such as Al₂O₃ or AlN, and for example of steatite. The separate component is fastened on the end of the discharge vessel by means of cement or adhesive.

The invention is suitable in particular for heavily loaded metal halide lamps, in which the ratio between the inner length IL and the maximum inner diameter ID of the discharge vessel, the so-called aspect ratio IL/ID, lies between 1.5 and 8.

It has been found that with these forms of burner, particularly when they have two end regions tapering toward the end, local end cooling is expedient. This improves the fill distribution in the burner, because the fill is preferentially deposited in the region behind the electrodes in the so-called electrode back space and therefore leads to an improved color stability as well as to an increased luminous efficiency. Particularly when using fills containing Na and/or Ce, extremely high luminous efficiencies can be achieved with high color rendering. It has been found that when a suitable operating method is used, the performance characteristic of the lamp can be influenced favorably so that a luminous efficiency of up to more than 150 lm/W can be achieved while maintaining a color rendering index Ra>80 stably in the long term. Such operating methods are specified for example in EP 1 560 472, EP 1 422 980, EP 1 729 324 and EP 1 768 469.

Regardless of the shaping of the wall between the electrodes, it is possible to influence and adjust the temperature gradient in heavily loaded burners, which typically reach a wall load of at least 30 W/cm² in the region of the axial length between the electrodes, through the selection of the application point for the cooling structure. The color temperature consistency and the efficiency of the resulting metal halide lamp can therefore be improved substantially.

By avoiding contact between the cooling structure and the seal (usually an electrode feed-through capillary), effective cooling at the application point of the cooling structure is ensured and the same time a heat flux onto the seal is avoided. This reduces the losses at the ends and increases the temperature gradients in the region of the seal.

This applies in particular for metal halide lamps which contain at least one of the halides of Ce, Pr or Nd, in particular together with halides of Na and/or Li. In this case, color temperature variations otherwise occur owing to distillation effects.

Use is preferable in lamps with a high aspect ratio of from 2 to 6 and in lamps with excitation of acoustic resonances, which are used to alleviate longitudinal segregation in a vertical burning position.

In particular, the seals are advantageously configured as capillaries. They may however also be configured differently—see for example DE-A 197 27 429, where a cermet pin is used.

A particularly good cooling effect can be achieved in lamps with a constant inner diameter, when the cooling ring has the same maximum diameter as the end region. A smaller diameter may, however, also be sufficient.

In general, the cooling ring has an inner diameter of from 1.4 to 2×DU (DU=outer diameter of the capillary). In particular, its wall thickness is about 0.3 to 3 mm. In particular, the end face connecting the inner diameter to the outer diameter may be chamfered. It may also be provided with a coating. The coating should be highly emissive. Suitable materials are in particular graphite or carbon, i.e. other carbon modifications such as for example DLC (diamond-like carbon).

In general, the cooling behavior may also be controlled by covering a part of the ring, such as the end face, with a coating of high emissivity.

PCA or any other conventional ceramic may be used as the material of the bulb. Likewise, the choice of fill is not subject to any particular restriction.

According to the invention, for high-pressure lamps with an approximately uniform wall thickness distribution and slimly terminating end shapes, a sometimes high color variance has previously been exhibited depending on the fill composition, owing to the strong distribution of the metal halide fill in the interior of the discharge vessel. Typically, the fill condenses in the region behind a line which is determined by projecting the electrode tip onto the inner burner surface. The fill positioning onto a zone of the surface inside the discharge vessel, which corresponds to a narrow temperature range, and into the residual volumes of the—optionally provided—capillaries, has previously not been adjustable accurately enough.

Previous discharge vessels often have a shape with an increased wall thickness on the end faces, for example in cylindrical forms of burners, and therefore generate an enlarged end surface. Another problem is the increased emission of IR radiation, due to the wall thickness-dependent specific emission coefficient of the ceramic, during operation of the discharge vessel in an evacuated or gas-filled outer bulb.

In this way, the majority of the fill is localized by a heat sink effect at the end of the discharge vessel, which determines the vapor pressure of the metal halides being used in the discharge vessels so that in ceramic lamp systems a satisfactory value of the variance of the color temperature of at most 75 K can be adjusted for sizeable lamp groups with the same operating power.

In spherical discharge vessels or those with hemispherical end shapes, or conically converging end shapes or elliptically formed end shapes and a cylindrical central part with a relatively high aspect ratio IL/ID of about 1.5 to 8, particularly serious problems occur. Owing to the tapering transition in the region of the seal, usually a capillary region, there are sometimes insufficient cooling effects at the end of the discharge vessel and therefore insufficient setting of the temperature, which is inadequate for accurately targeted fill deposition in a narrow temperature range of the inner wall.

With a burner geometry which does not comprise a cooling structure—see FIG. 8—a very small temperature gradient is generated from the burner body to the sealing structure, which leads to preferential distillation of the fill in the feed-through structure.

With a burner geometry in which the seal is configured as a solid plug, see FIG. 9, an increased cooling effect of the outer surface is generated. At the same time, however, a large amount of heat is introduced into the adjacent seal, which leads to an increased burner mass and increased thermal conduction losses.

Both solutions have disadvantages for the performance characteristic of the metal halide lamp.

Another known solution (FIG. 10) involves fins or fin-like structures. Although these increase the cooling surface area, they nevertheless form a thermal bridge between the burner end and the seal, particularly when short cooling lengths are preferred and the cooling structure has an increased number of cooling fins.

These disadvantages are avoided by the cooling structure according to the invention in the form of a ring. In a preferred embodiment of the invention, some or all of the cooling structure is provided with a coating. This consists of a material which has an increased hemispherical emissivity ε in the temperature range of between 650 and 1000° C. in the near infrared (NIR), particularly in the wavelength range of between 1 and 3 μm, compared with the ceramic material of the cooling structure. The coating should preferably be applied in the region of the transition between the end of the discharge vessel and the seal.

Refractory coatings with a hemispherical emission coefficient ε are suitable as coating materials, where ε preferably satisfies ε≧0.6. These include graphite, mixtures of Al₂O₃ with graphite, mixtures of Al₂O₃ with carbides of the metals Ti, Ta, Hf, Zr, and of semimetals such as Si. Mixtures are also suitable which additionally contain other metals to adjust possibly desired electrical conductivity.

Both measures may of course be combined with one another, so that some of the surface emission increase is achieved by increasing the surface area by the ring structure, and at the same time some is achieved by coating parts of this ring structure or the cooler adjacent sealing regions.

Overall, a range of advantages are obtained when using an integral cooling ring in ceramic discharge vessels:
1. more effective cooling together with a relatively low additional mass of ceramic;
2. reduction of the longitudinal heat flux into the seal;
3. significantly increased flexibility of the surface area adjustment in the end region;
4. reduction of the shadowing effects in the solid angle range of the electrode feed;
5.adjustability of an effective local thermostat effect by means of relatively small surface regions.

These properties are important in particular for heavily loaded forms of discharge vessels with a small total surface area and possibly an increased aspect ratio, since under these conditions local cooling by a heat flux over a relatively large wall cross-sectional area is difficult.

The total mass of the discharge vessel is increased only insubstantially by this type of ring cooling, and it therefore remains below a critical value which would detrimentally affect the starting behavior of the lamp on ignition. There is therefore an expedient compromise between good ignition and effective cooling. This measure allows very high color stability while deliberately tolerating poor isothermality. This is done in contrast to the previous goal of optimal isothermality, and makes it possible to determine the fill condensation zone exactly by deliberate configuration of a temperature gradient.

The cooling effect may in particular be controlled by the maximum height of the ring cooling, particularly when it is placed on the end region of the discharge vessel, since the derivation from another temperature level takes place according to the application height.

A particular advantage of such integral ring cooling is that it not only cools effectively, but it is also simple to produce when using modern fabrication methods such as injection molding, slip casting or rapid prototyping.

### BRIEF DESCRIPTION OF THE DRAWINGS

The invention will be explained in more detail below with the aid of several exemplary embodiments. In the figures:

FIG. 1 shows a high-pressure discharge lamp having a discharge vessel;

FIG. 2 shows a detail of the discharge lamp of FIG. 1 in perspective (FIG. 2a) and in longitudinal section (FIG. 2b);

FIGS. 3-4 show another exemplary embodiment of an end region of a discharge vessel;

FIGS. 5-6 show another exemplary embodiment of a discharge vessel;

FIG. 7 shows another exemplary embodiment of a discharge vessel;

FIGS. 8-10 show exemplary embodiments of an end region according to the prior art;

FIGS. 11-13 show further exemplary embodiments of an end region of a discharge vessel.

### PREFERRED EMBODIMENT OF THE INVENTION

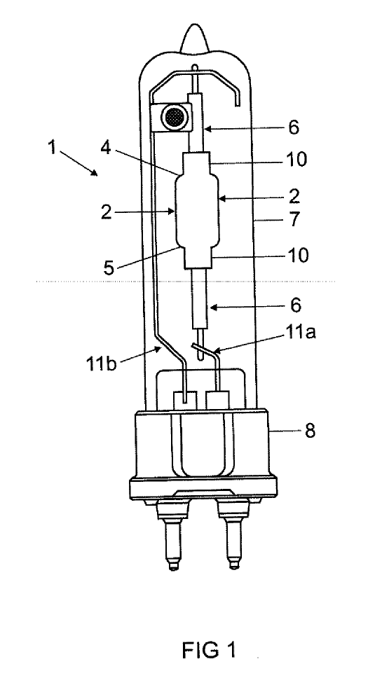

FIG. 1 shows a metal halide lamp 1. It consists of a tubular discharge vessel 2 made of ceramic, into which two electrodes (not visible) are inserted. The discharge vessel has a central part 5 and two ends 4. Two seals 6, which are configured here as capillaries, are placed on the ends. The discharge vessel and the seals are preferably produced integrally from a material such as PCA.

The discharge vessel 2 is enclosed by an outer bulb 7, which adjoins a cap 8. The discharge vessel 2 is held in the outer bulb by means of a frame, which contains a short electrical feed 11a and a long electrical feed 11b. On each of the seals 6, there is a ring cooling structure 10 which extends around the seal.

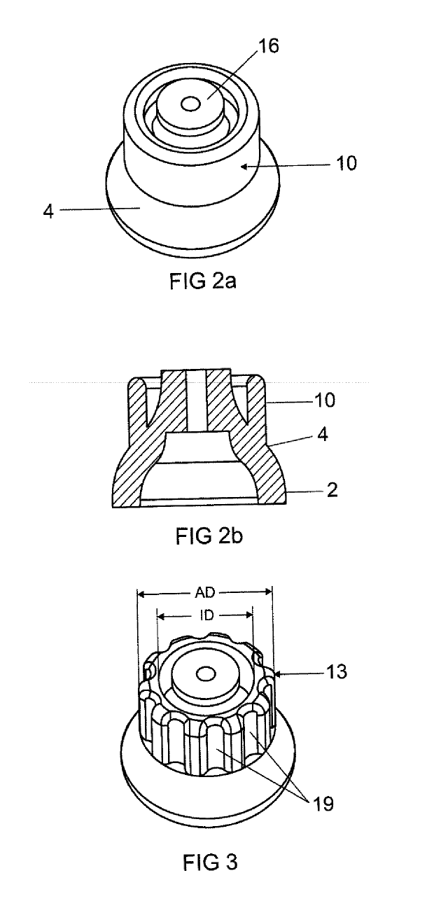

FIG. 2a shows a ring cooling structure 10 in perspective view, in conjunction with a short seal 16. FIG. 2b shows a longitudinal section of the region of a seal 16. The ring cooling structure 10 is placed in the tapering end region 4 of the discharge vessel 2, and encloses the seal with a small spacing.

FIG. 3 shows a ring cooling structure 13 which, instead of a constant inner diameter and outer diameter, has fin-shaped or semicircularly cut-out structures 19, which are placed externally on the ring 13. Therefore, although the inner diameter ID is constant, the outer diameter AD varies periodically.

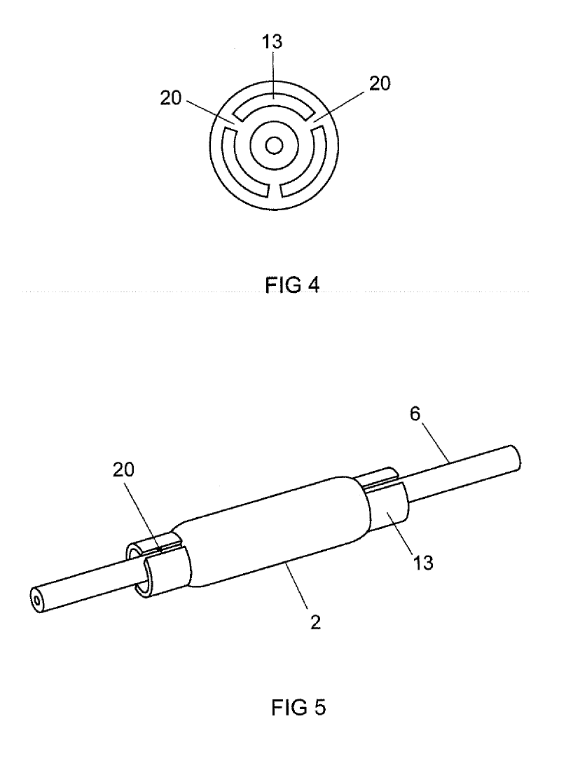

Lastly, it is also possible to make small recesses 20 in the ring structure 13—see FIG. 4. This is intended to increase the radiating surface area. The number of recesses is preferably up to three, as shown here.

FIG. 5 shows a discharge vessel 2 in which the seal is produced by a capillary. The cooling ring 13 has a slit 20. Here, a slit is intended to mean its angular length is very small in comparison with the angular length of the remaining ring. The slits together make up typically at most 10% of the total angular length of 360°. This value should be selected as small as possible because the interruptions reduce the cooling power. Such concentric or partially concentrically arranged (partially) cylindrical appendages of the cooling ring in the region of the tapering inner contour form a cooling structure, without causing a heat flux toward the burner end region longitudinally in the direction of the burner axis.

The cooling effect on the surface zones of the burner vessel can be locally adjusted through the application site, wall thickness and height of the cooling ring.

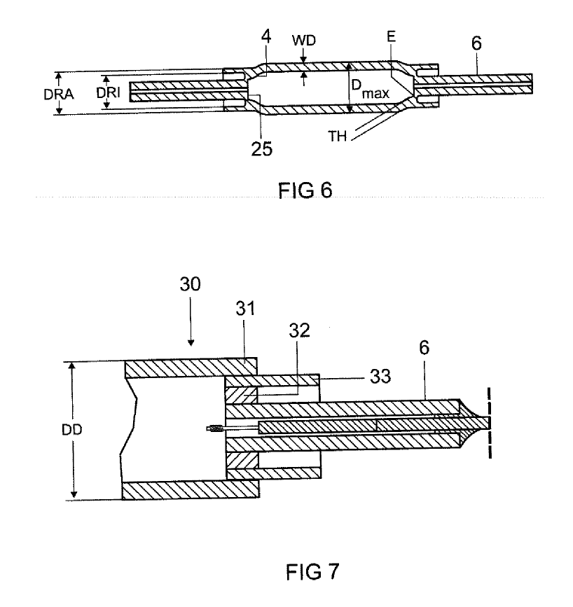

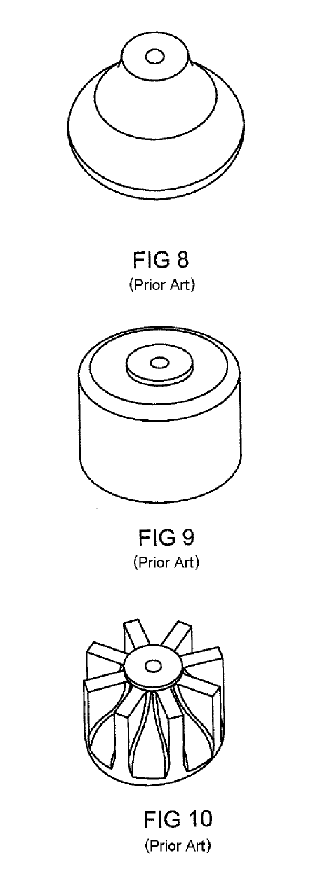

The application point of the cooling ring on the tapering end region 4 is given by the inner diameter DR1, where DR1 lies in the range of between 95% and 25% of the maximum diameter Dmax of the discharge vessel. DR1 preferably lies between 80% and 25% of Dmax. The wall thickness TH of the tapering end region 4 is often, as shown here, not constant. The orientation of the annularly arranged cooling structure is preferably selected (FIG. 6) so that the application point of the ring structure lies outside the narrowest position E of the tapering end region 4. Often, the entry of the capillary is configured as a plane face 25 which is transverse to the lamp axis, which necessarily gives a narrowest position. DRA is the outer diameter of the ring structure.

The minimum wall thickness in the end region is preferably 20-80% of the maximum wall thickness in the end region, as occurs in particular at the start of the tapering.

WD is the wall thickness at the center of the discharge vessel. The ring structure 13 should as far as possible avoid a wall thickness TH>WD occurring in the tapering end region 4, since otherwise there will be an increased heat flux into the capillary cross-sectional area and this can lead to increased thermal conduction losses.

FIG. 7 shows an exemplary embodiment of a discharge vessel 30 in which the end 31 of the discharge vessel does not taper, but instead the discharge vessel has a constant diameter DD. The capillary 6 is placed in a plug 32. The ring structure is fitted as a further plug-like cylindrical part 33 between the plug 32 and the end 31 of the discharge vessel, and is respectively sintered to the plug 32 and the discharge vessel 30.

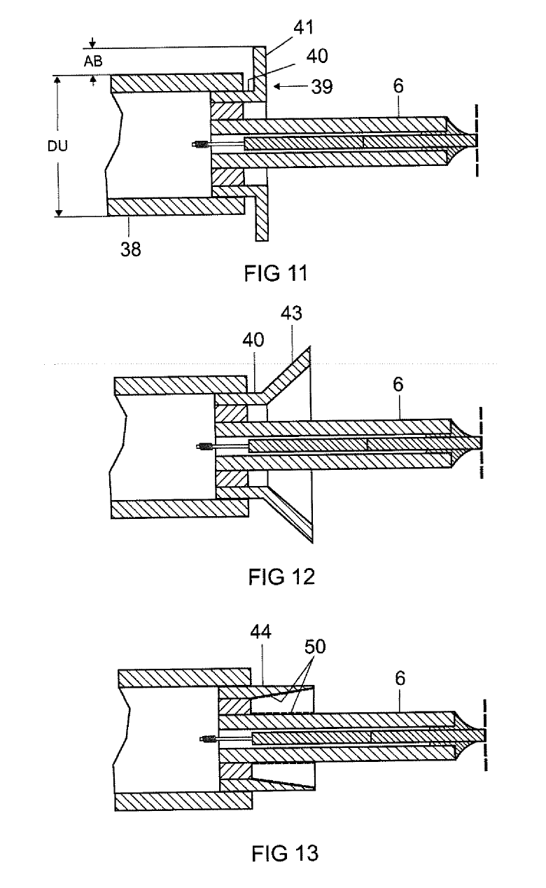

Integral cooling structures should approximately be axially parallel, so that they are easy to fabricate. However, cooling structures which have a modified geometry and deviate from axial parallelism are advantageous. This elegantly and effectively avoids back-reflection onto the end of the discharge vessel, in particular onto the capillary. FIG. 11 shows an exemplary embodiment in which a ring structure 39 has an axially parallel base body 40, which encloses a plug and has a radiation body inclined outward from the axis in the form of a projecting circumferential fin or individual spikes 41. A plurality of spikes may also be arranged axially in succession on a base body.

The deviation of the radiation body from the longitudinal axis is preferably about 90°, in order to substantially prevent back-reflections onto the capillary 6. It is advantageous for the projecting length AB to significantly extend the diameter DU of the discharge vessel 38, in order to minimize any back-reflections.

FIG. 12 shows an exemplary embodiment in which a plate-like end part is placed on the base body 40 as a radiating body 43 which makes an angle of approximately 45° with the longitudinal axis.

FIG. 13 shows an exemplary embodiment in which the problem of back-reflection has been resolved in another way. Here, the ring structure converges acutely at the opposite end from the discharge, such that its internally lying wall side which faces toward the capillary is chamfered (44) so that the emitted radiation travels obliquely outward after reflection from the capillary. For improved suppression of the detrimental IR radiation, an IR-reflecting coating 50 is furthermore preferably applied as known per se onto at least one of the two surfaces: capillary and/or inner side of the ring structure.

1. A high-pressure discharge lamp, comprising:
an elongate ceramic discharge vessel with a central part and two ends and an axis, the ends being closed by seals, electrodes which extend into the discharge volume enclosed by the discharge vessel being anchored in the seals, and a fill which contains metal halides being accommodated in the discharge vessel,
wherein a ring structure, which is separated from the seal and extends around the seal, is placed on at least one end.

2. The high-pressure discharge vessel as claimed in claim 1, wherein at least one base body of the ring structure extends axially parallel outward.

3. The high-pressure discharge vessel as claimed in claim 1, wherein the end tapers and the ring structure is placed in the tapering end region.

4. The high-pressure discharge vessel as claimed in claim 1, wherein the discharge vessel has an aspect ratio of from 1.5 to 8.

5. The high-pressure discharge vessel as claimed in claim 1, wherein the ring structure is placed outside the narrowest position of the end region.

6. The high-pressure discharge vessel as claimed in claim 1, wherein the outer diameter of the ring structure is constant or varies periodically.

7. The high-pressure discharge vessel as claimed in claim 1, wherein the seals are configured as capillaries.

8. The high-pressure discharge vessel as claimed in claim 1, wherein the ring structure has at most three interruptions.

9. The high-pressure discharge vessel as claimed in claim 1, wherein the wall thickness of the ring structure lies in the range of from 0.5 to 3 mm.

10. The high-pressure discharge vessel as claimed in claim 9, wherein the end side of the ring structure is chamfered.

11. The high-pressure discharge vessel as claimed in claim 2, wherein the ring structure has an axially parallel base body and a radiation body inclined outward from the longitudinal axis.

12. The high-pressure discharge vessel as claimed in claim 10,
wherein the end side of the ring structure is chamfered and provided with a coating.
